(19) United States
(12) Patent Application Publication
(10) Pub. No.: US 2014/0062893 A1
(43) Pub. Date: Mar. 6, 2014

(54) SYSTEM AND METHOD FOR REDUCING THE PROBABILITY OF ACCIDENTAL ACTIVATION OF CONTROL FUNCTIONS ON A TOUCH SCREEN

(71) Applicant: Amit Nishikant Kawalkar, Bangalore (IN)

(72) Inventor: Amit Nishikant Kawalkar, Bangalore (IN)

(73) Assignee: HONEYWELL INTERNATIONAL INC., Morristown, NJ (US)

(21) Appl. No.: 13/597,021

(22) Filed: Aug. 28, 2012

(51) Int. Cl. G06F 3/041

(52) U.S. Cl. 345/173

(57) ABSTRACT

A system and method is provided for detecting the inadvertent touch of a user interface element on a touch screen. An analog signal stream associated with a touch sensor parameter is converted into a plurality of real-time, discrete signal stream packets. At least one of a plurality of modes for analyzing the discrete signal stream packets is selected, and the discrete signal stream packets are processed in accordance with the rules of the selected mode to determine if the user interface element has been inadvertently touched.

### TECHNICAL FIELD

Embodiments of the subject matter described herein relate generally to vehicular display systems. More particularly, embodiments of the subject matter described herein relate to an intelligent touch screen controller and method for using the same to reduce inadvertent touch and the effects thereof on a cockpit touch screen controller (TSC).

### BACKGROUND

While touch screen controllers are being introduced as components of modern flight deck instrumentation, they are constrained by the problems associated with inadvertent touch, which may be defined as any system detectable touch issued to the touch sensors without the pilot's operational consent. That is, a pilot may activate touch screen interface elements inadvertently because of turbulence, vibrations, or aspects of the pilot's physical and cognitive workload, resulting in possible system malfunction or operational error. For example, potential sources of inadvertent touches include accidental brush by a pilot's hand or other physical object while the pilot is not interacting with the touch screen controller; e.g. touch resulting when moving across the flight deck or involuntary movements (jerks) induced by turbulence. Accidental activation may also be caused by a pilot's non-interacting fingers or hand portions. Furthermore, environmental factors may also result in inadvertent touching depending on the touch technology employed; e.g. electromagnetic interference in the case of capacitive technologies, or insects, sunlight, pens, clipboards, etc., in the case of optical technologies. Apart from the above described side effects associated with significant control functions, activation of even less significant control functions degrades the overall functionality and usability of touch screen interfaces.

In view of the foregoing, it would be desirable to provide a system and method for reducing the effects of inadvertent touch on a TSC by (a) establishing valid touch interaction requirements that intelligently differentiate between intentional and unintentional touch and generates touch events accordingly, (b) associates one or more system level performance requirements to various user interface event types or individual user interface elements, and/or (c) associates touch interaction elements for successful activation of the corresponding control function.

### BRIEF SUMMARY

This summary is provided to introduce a selection of concepts in a simplified form that are further described below in the detailed description. This summary is not intended to identify key or essential features of the claimed subject matter, nor is it intended to be used as an aid in determining the scope of the appended claims.

A method is provided for detecting the inadvertent touch of a user interface element on a touch screen controller (TSC). An analog signal stream associated with a plurality of touch sensor parameters is converted into corresponding real-time, discrete signal stream packets. At least one of a plurality of modes for analyzing the discrete signal stream packets is selected, and the discrete signal stream packets are processed in accordance with the rules of the selected mode to determine if the user interface element has been inadvertently touched.

A system for determining if a user has inadvertently touched a user interface element of a touch screen controller is also provided. The system comprises a plurality of touch sensors, and a controller coupled to the plurality of touch sensors configured to (a) convert an analog input stream corresponding to a touch sensor parameter into a real-time signal profile; (b) receive a mode control signal indicative of which mode of a plurality of modes should be used to analyze the real time signal profile; and (c) process the real time signal profile using the selected mode to determine if the user interface element was inadvertently touched.

A method for determining if a user interface element on a touch screen controller (TSC) was inadvertently touched is also provided and comprises converting an analog signal stream corresponding to a touch sensor parameter into a plurality of real-time, discrete signal stream packets. A predetermined signal profile is stored in a first database. A representative signal profile derived from the discrete signal stream is compared with the predetermined signal profile, and a predetermined rule is associated with a successful touch interaction. Finally, a determination is made as to whether or not the signal profile spectrum complies with minimum performance requirements associated with its respective user interface element.

### BRIEF DESCRIPTION OF THE DRAWINGS

A more complete understanding of the subject matter may be derived by referring to the detailed description and claims when considered in conjunction with the following figures, wherein like reference numerals refer to similar elements throughout the figures, and wherein:

FIG. 1 is a block diagram of an aircraft cockpit display system including a touch screen display and a touch screen controller;

FIG. 2 illustrates a conformal tap gesture signal distribution pattern and signal sensitivity zones;

FIG. 3 illustrates an exemplary touch pattern discrete signal profile corresponding to a user's positive intentions to produce a user interface element tap;

FIG. 4 illustrates an exemplary touch sensor parameter discrete signal profile corresponding to a user's accidental touch corresponding to negative intentionality;

FIG. 5 illustrates an exemplary touch sensor parameter discrete signal profile corresponding to an inadvertent tap;

FIG. 6 is a block diagram of an intelligent touch screen controller in accordance with an exemplary embodiment;

FIG. 7 illustrates a noisy waveform;

FIG. 8 illustrates the waveform of FIG. 7 after filtering;

FIG. 9 illustrates the waveform of FIG. 8 after noise reduction;

FIG. 10 illustrates the waveform of FIG. 9 after sampling and conversion to a discrete time signal;

FIG. 11 illustrates a data packet format in accordance with an exemplary embodiment;

FIG. 12 is a flow chart of an input signal synthesizer process in accordance with an exemplary embodiment;

FIG. 13 illustrated a user interface event record definition table;

FIG. 14 is a flow chart of a controller core algorithm in accordance with an exemplary embodiment;

FIG. 15 illustrates an exemplary discrete input signal converted into zones in accordance with an embodiment;

FIG. 16 illustrates an exemplary computed interaction profile in accordance with an embodiment;

FIG. 17 illustrates an exemplary positive interaction intent database format;

FIG. 18 is a flow chart of a positive interaction intent recognition process in accordance with an embodiment;

FIG. 19A illustrates a user interface element in its normal state;

FIG. 19B illustrates initial visual cue displacement;

FIG. 19C illustrates gradual increases in size to capture displaced visual cues;

FIG. 19D illustrates the user interface element after capturing the final visual cue and having an enhanced background;

FIG. 20 illustrates an instability tolerance concept;

FIG. 21 illustrates an exemplary touch sensor parameter signal profile rule for valid control function activation;

FIG. 22 is a flow chart of a touch screen parameter signal profile rule-based control function activation process in accordance with an exemplary embodiment;

FIG. 23 illustrates an exemplary touch parameter signal dynamic range band distribution;

FIG. 24 illustrates an exemplary user interface and system control function significance map;

FIG. 25 illustrates a signal level control function and touch screen parameter signal dynamic range band map; and

FIG. 26 is a flow chart illustrating a user interface event mode process in accordance with an exemplary embodiment.

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, brief summary, or the following detailed description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to graphics and image processing, touch screen displays, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

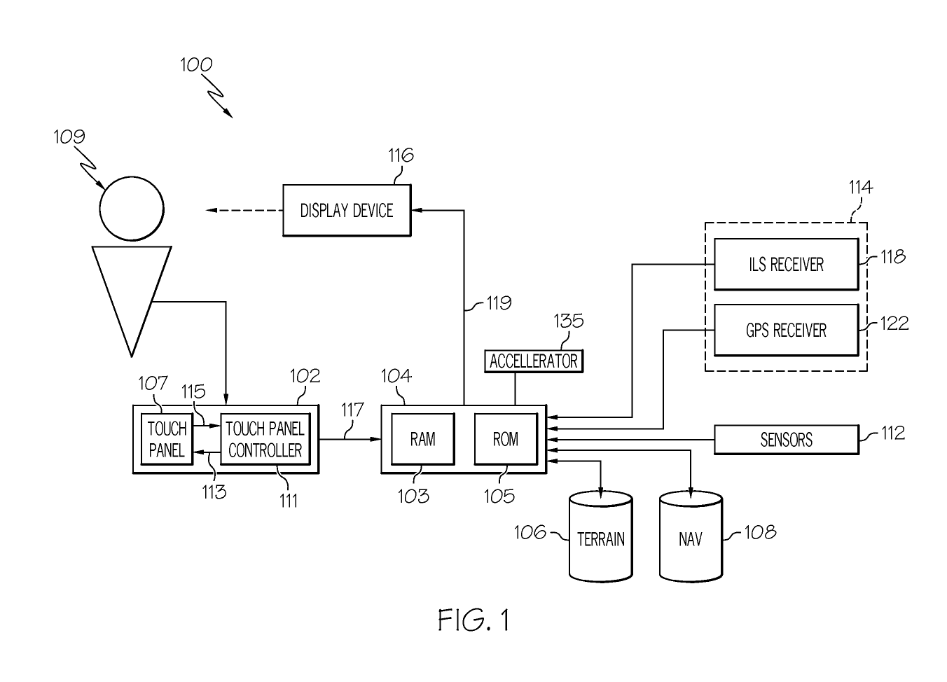

Though the method of the exemplary embodiment's touchscreen may be used in any type of vehicle, for example, trains and heavy machinery, automobiles, trucks, and water craft, the use in an aircraft cockpit display system will be described as an example. Referring to FIG. 1, a flight deck display system 100 includes a user interface 102, a processor 104, one or more terrain databases 106 sometimes referred to as a Terrain Avoidance and Warning System (TAWS), one or more navigation databases 108, sensors 112, external data sources 114, and one or more display devices 116. The user interface 102 is in operable communication with the processor 104 and is configured to receive input from a user 109 (e.g., a pilot) and, in response to the user input, supplies command signals to the processor 104. The user interface 102 may be any one, or combination, of various known user interface devices including, but not limited to, one or more buttons, switches, or knobs (not shown). In the depicted embodiment, the user interface 102 includes a touch screen display 107 and a touch screen controller (TSC) 111. The TSC 111 provides drive signals 113 to a touch screen display 107, and a sense signal 115 is provided from the touch screen display 107 to the touch screen controller 111, which periodically provides a control signal 117 of the determination of a touch to the processor 104. The processor 104 interprets the controller signal 117, determines the application of the digit on the touch screen 107, and provides, for example, a controller signal 117 to the touch screen controller 111 and a signal 119 to the display device 116. Therefore, the user 109 uses the touch screen 107 to provide an input as more fully described hereinafter.

The processor 104 may be implemented or realized with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. In the depicted embodiment, the processor 104 includes on-board RAM (random access memory) 103, and on-board ROM (read-only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. The software executing the exemplary embodiment is stored in either the ROM 105 or the RAM 103. It will be appreciated that this is merely exemplary of one scheme for storing operating system software and software routines, and that various other storage schemes may be implemented.

The memory 103, 105 may be realized as RAM memory, flash memory, EPROM memory, EEPROM memory, registers, a hard disk, a removable disk, a CD-ROM, or any other form of storage medium known in the art. In this regard, the memory 103, 105 can be coupled to the processor 104 such that the processor 104 can be read information from, and write information to, the memory 103, 105. In the alternative, the memory 103, 105 may be integral to the processor 104. As an example, the processor 104 and the memory 103, 105 may reside in an ASIC. In practice, a functional or logical module/component of the display system 100 might be realized using program code that is maintained in the memory 103, 105. For example, the memory 103, 105 can be used to store data utilized to support the operation of the display system 100, as will become apparent from the following description.

No matter how the processor 104 is specifically implemented, it is in operable communication with the terrain databases 106, the navigation databases 108, and the display devices 116, and is coupled to receive various types of inertial data from the sensors 112, and various other avionics-related data from the external data sources 114. The processor 104 is configured, in response to the inertial data and the avionics-related data, to selectively retrieve terrain data from one or more of the terrain databases 106 and navigation data from one or more of the navigation databases 108, and to supply appropriate display commands to the display devices 116. The display devices 116, in response to the display commands, selectively render various types of textual, graphic, and/or iconic information.

The terrain databases 106 include various types of data representative of the terrain over which the aircraft is flying, and the navigation databases 108 include various types of navigation-related data. The sensors 112 may be implemented using various types of inertial sensors, systems, and or subsystems, now known or developed in the future, for supplying various types of inertial data, for example, representative of the state of the aircraft including aircraft speed, heading, altitude, and attitude. The ILS 118 provides aircraft with horizontal (or localizer) and vertical (or glide slope) guidance just before and during landing and, at certain fixed points, indicates the distance to the reference point of landing on a particular runway. The GPS receiver 124 is a multi-channel receiver, with each channel tuned to receive one or more of the GPS broadcast signals transmitted by the constellation of GPS satellites (not illustrated) orbiting the earth.

The display devices 116, as noted above, in response to display commands supplied from the processor 104, selectively render various textual, graphic, and/or iconic information, and thereby supplies visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat screen displays such as various types of LCD (liquid crystal display) and TFT (thin film transistor) displays. The display devices 116 may additionally be implemented as a screen mounted display, or any one of numerous known technologies. It is additionally noted that the display devices 116 may be configured as any one of numerous types of aircraft flight deck displays. For example, it may be configured as a multi-function display, a horizontal situation indicator, or a vertical situation indicator, just to name a few. In the depicted embodiment, however, one of the display devices 116 is configured as a primary flight display (PFD).

In operation, the display device 116 is also configured to process the current flight status data for the host aircraft. In this regard, the sources of flight status data generate, measure, and/or provide different types of data related to the operational status of the host aircraft, the environment in which the host aircraft is operating, flight parameters, and the like. In practice, the sources of flight status data may be realized using line replaceable units (LRUs), transducers, accelerometers, instruments, sensors, and other well-known devices. The data provided by the sources of flight status data may include, without limitation: airspeed data; groundspeed data; altitude data; attitude data, including pitch data and roll data; yaw data; geographic position data, such as GPS data; time/date information; heading information; weather information; flight path data; track data; radar altitude data; geometric altitude data; wind speed data; wind direction data; etc. The display device 116 is suitably designed to process data obtained from the sources of flight status data in the manner described in more detail herein.

There are many types of touch screen sensing technologies, including capacitive, resistive, infrared, surface acoustic wave, and embedded optical. All of these technologies sense touch on a screen. A touch screen is disclosed having a plurality of buttons, each configured to display one or more symbols. A button as used herein is a defined visible location on the touch screen that encompasses the symbol(s). Symbols as used herein are defined to include alphanumeric characters, icons, signs, words, terms, and phrases, either alone or in combination. A particular symbol is selected by sensing the application (touch) of a digit, such as a finger or a stylus, to a touch-sensitive object associated with that symbol. A touch-sensitive object as used herein is a touch-sensitive location that includes a button and may extend around the button. Each button including a symbol has a touch-sensing object associated therewith for sensing the application of the digit or digits.

Inadvertent touch may result from the accidental brush by pilot's hand or any physical object capable of issuing detectable touch to the touch sensor, while the pilot is not actually interacting with the touch controller. These kinds of inadvertent touches are issued while moving across the flight deck or due to jerks induced by the turbulence. In addition, accidental touch may result from the pilot's non-interacting fingers or hands; e.g. if the pilot is interacting with the system using the pilot's index finger, and the pilot's pinky finger, which is relatively weak, accidentally touches a nearby user interface element.

Some inadvertent touches are caused by environmental factors that depend upon the touch technology used in the system; e.g. electromagnetic interference in capacitive technologies; and insects, sunlight, pens etc. with optical technologies. Ideally, all touches not intentionally issued by the pilot or crew member should be rejected; however, this would not be practical. A practical solution should consider the seriousness of an inadvertent touch and subsequent activation of the control function; some may have a relatively minor effect and others may have a more significant effect. In addition, the control function interface interaction characteristics (time on task, workload, accessibility, ease of use etc.) should remain equivalent to the interface available in non-touch screen flight decks or through alternate control panels. If special interaction methods are employed for portions of the user interface, then the interaction method should be intuitively communicated to the pilot, without the need for additional training or interaction lag. Mandatory interaction steps, which would increase the time on task and reduce interface readiness of the touch interfaces, should not be added.

The following intelligent touch screen controller methods address the above issues and provide means for differentiating between inadvertent and intentional touch interaction acceptable for activation of a corresponding control function in accordance with exemplary embodiments. These methods, while capable and self-sufficient for individual operation, can be made to operate in combination to further reliability, especially during demanding situations such as operation in turbulence.

The first method includes the specification of valid touch interaction requirements that correspond to intentional activation of the control functions by the user. These touch interaction requirements (involving one or more touch sensor parameters) can be modeled and specified at the system design phase and/or altered during runtime to reflect changes in (1) the operating situation, (2) the significance of the function and/or (3) other usability requirements. This method intelligently differentiates between intentional and unintentional touch interactions and generates touch events accordingly.

In the second method, one or more system level performance requirements are associated with various user interface event types of individual user interface elements. The system level performance requirements could be combination of control function significance levels, ease of activation, and/or instability tolerance. The user interface events are generated if and only if the signal profiles corresponding to one or more touch sensor parameters required for constructing and generating the event satisfies these requirements.

In the third method, touch interaction is associated with corresponding control function. These touch interaction rules are composed of combination of one or more touch parameters (e.g. touch force, touch sensitivity, touch surface size, touch duration etc.) and are noticeably temporal and spatial in nature from user's perspective. This spatial, temporal and parametric touch interaction requirement is conveyed to the user in real time through an intuitive progressive visual feedback. This progressive visual feedback acts as visual targets corresponding to the sub-components of the interaction requirement defined by the rule/pattern, which does not mandate explicit user training towards successful activation of the control functions incorporating this method.

Positive Interaction Intent Recognition (PIIR)

This method recognizes if the real-time input signal stream corresponding to one or more touch parameters correspond to a predefined pattern over its respective dynamic range that clearly indicates a user's valid and positive interaction intent. The touch interactions not having deterministic and predefined patterns are rejected. Thus, the user interface events are generated only if the user's positive interaction intent is detected, reducing the occurrence of accidental activation of control functions due to inadvertent touches. Inadvertent touches are detected by associating one or more touch sensor parameter signal profiles to a user's positive interaction intent.

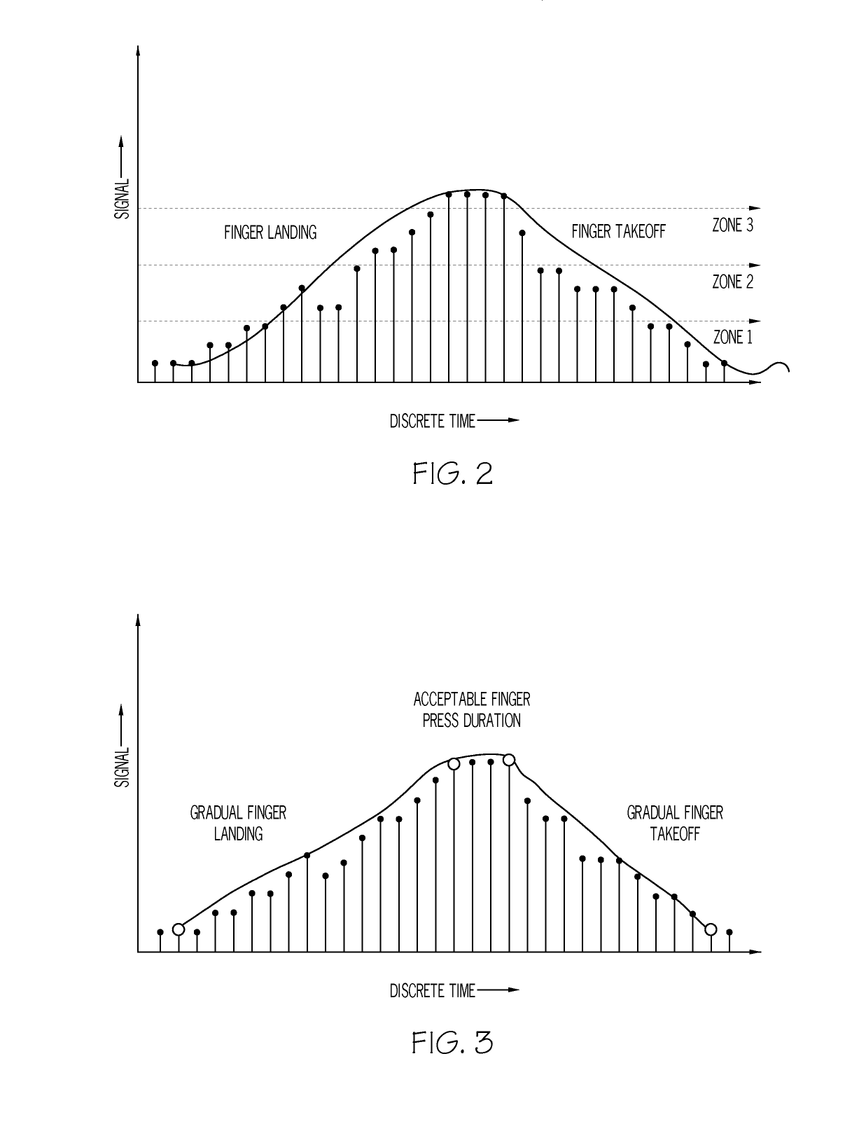

This method may be used to differentiate between an accidental brush or tap and a valid interaction corresponding to intentional control function activation. The range of measurable signal values may be divided into N zones corresponding to N different threshold values. For an interaction to be a valid one, a corresponding rule or pattern for the measured input signals is defined. The input signal pattern is then compared to the predefined rule or pattern. If the measured input signal pattern falls within the tolerance limits of the predefined input signal pattern, then corresponding interaction is determined to be VALID and an “ACTIVATION” event is registered. For example, referring to FIG. 2, the range of measurable signal values is divided into three distinct zones corresponding to three different signal threshold levels. FIG. 2 demonstrates a predefined pattern for a valid “TAP” gesture. That is, it is expected that the measured input signal will first gradually reach and exceed the threshold values of Zone 1, Zone 2 and Zone 3 and then gradually fall below the threshold values of Zone 3, Zone 2 and Zone 1. If this rule is satisfied by the user's tap, then and only then is a “TAP” event registered. Thus, this method detects if the user has positive intentions of interacting with the system. The rules can be further defined through experimentation to determine a reasonably constant signal stream pattern for a given gesture or interaction to be positive.

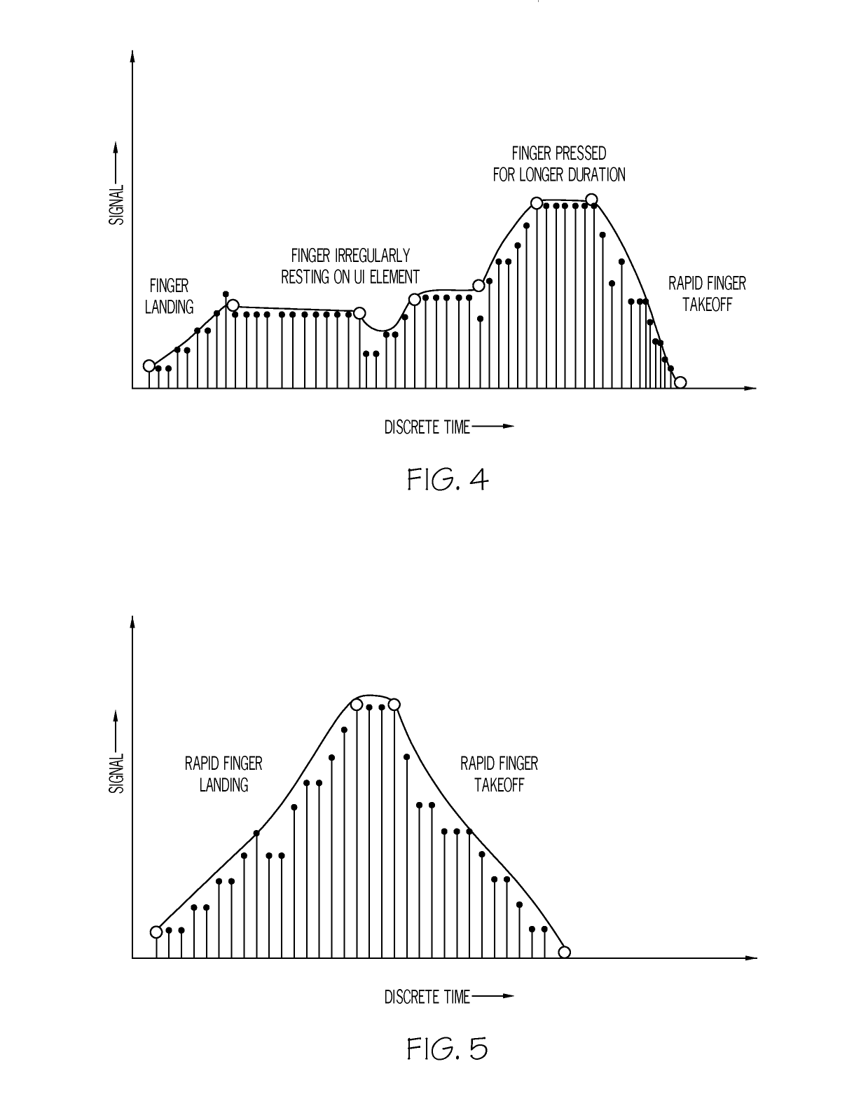

Referring to FIG. 3, there is shown another example of an input signal profile corresponding to a TAP interaction that follows a specific and predictable pattern that demonstrates a user's positive interaction intent to issue a “control button press” event. That is, the profile shown in FIG. 3 is characterized by an initial gradual finger landing, followed by an acceptable finger press duration that is, in turn, followed by a gradual finger removal. FIG. 4, however, shows a rather unpredictable profile that corresponds to a user's accidental touch. As can be seen, the profile in FIG. 4 comprises a finger landing, irregularly resting on a user interface element, a finger pressed for a longer duration, and finally on rapid finger takeoff FIG. 5 illustrates an exemplary touch sensor parameter discrete signal profile corresponding to an inadvertent tap characterized by a rapid finger landing and a rapid finger takeoff, also indicative of a user's negative intention.

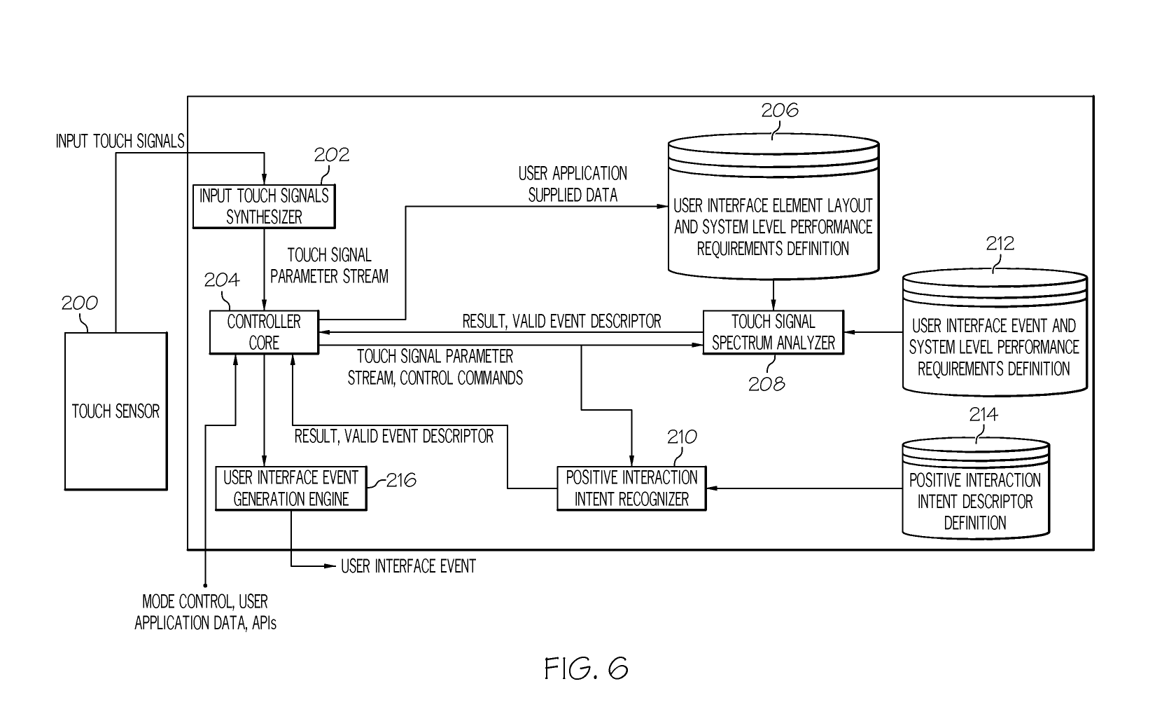

FIG. 6 is a block diagram of an intelligent touch screen controller in accordance with an embodiment. Touch sensors 200 generate real time signals corresponding to one or more touch sensor parameters resulting from user touch interactions. Any touch sensor technology may be employed (e.g. resistive, IR, etc.); however, the embodiments herein will be described in connection with projected capacitive (PCAP) sensors.

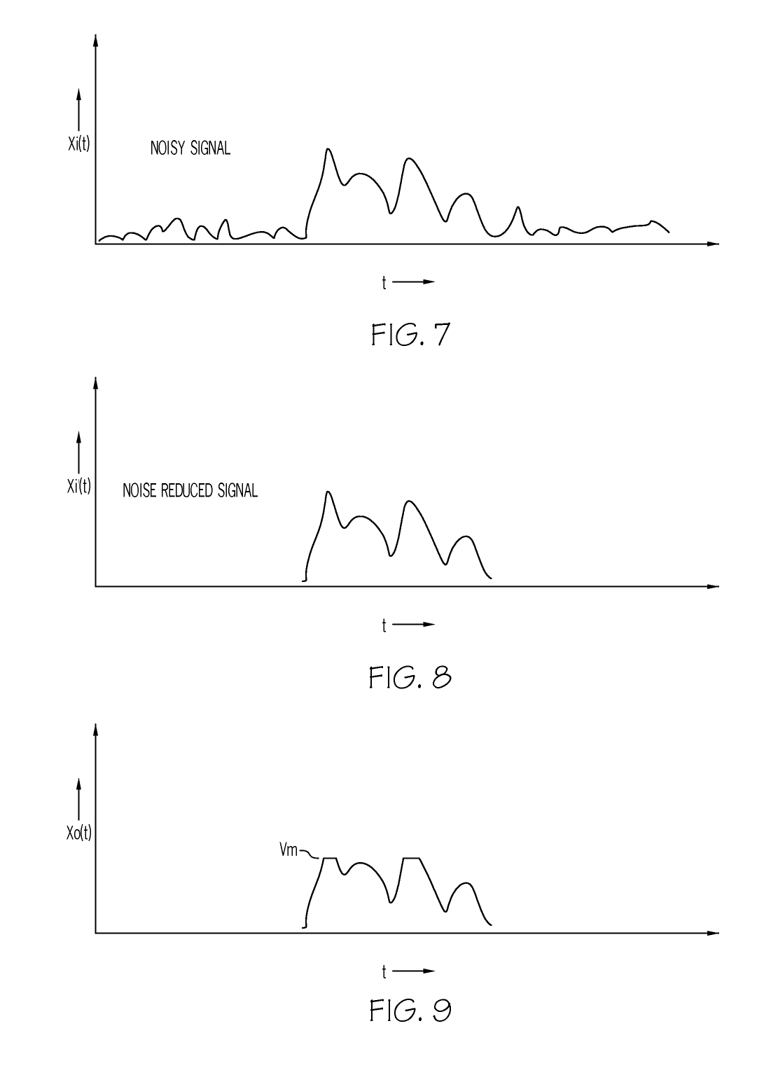

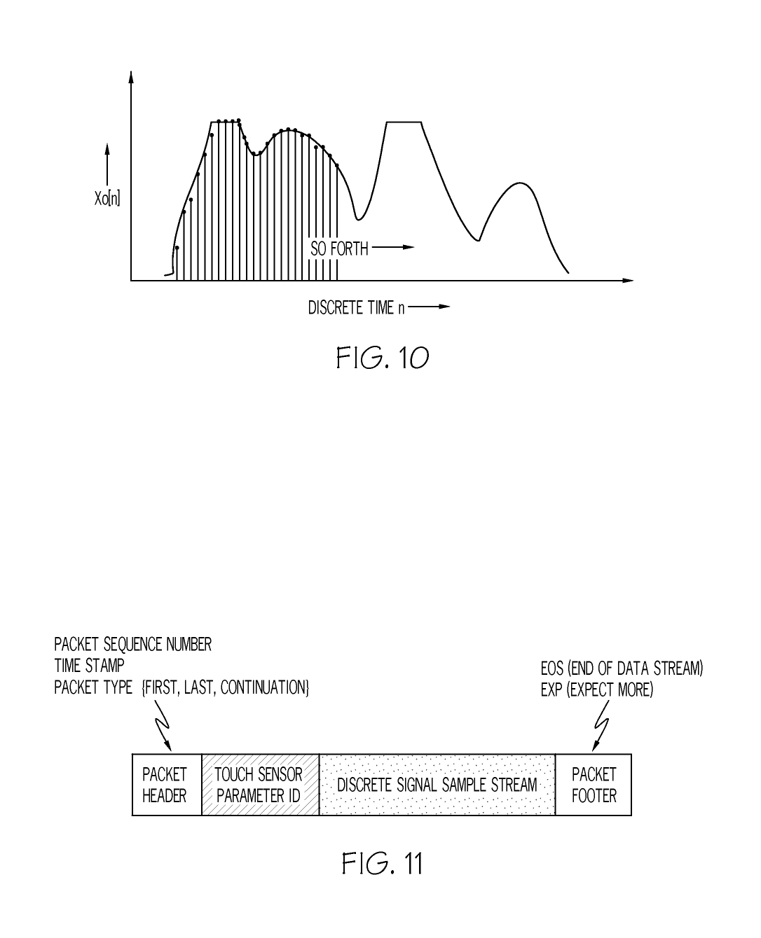

These real time signals are applied to input touch signal synthesizer 202, which filters the signals and further creates separate signal streams corresponding to various touch sensor parameters. This separation is utilized in later stages for analysis and evaluation of each signal. For example, the input touch synthesizer performs the necessary signal processing to transform the input signals corresponding to various touch sensor parameters into discrete signal streams useable by subsequent stages. First, synthesizer 202 reduces the noise content in the input analog signal (FIG. 7) as is shown in FIG. 8. The noise reduced signal is then clipped as shown in FIG. 9, where X(o)t=Vm wherein xi(t)>Vm. Otherwise, X(o)t=xi′(t). After clipping, the signal is passed through an analog-to-digital converter that converts the continuous time signal to discrete time signals (Xo[n]) (FIG. 10). A data packet is then created that bundles the discrete time signal stream and its corresponding touch sensor parameter together. These data packages, illustrated in FIG. 11, are processed in subsequent stages.

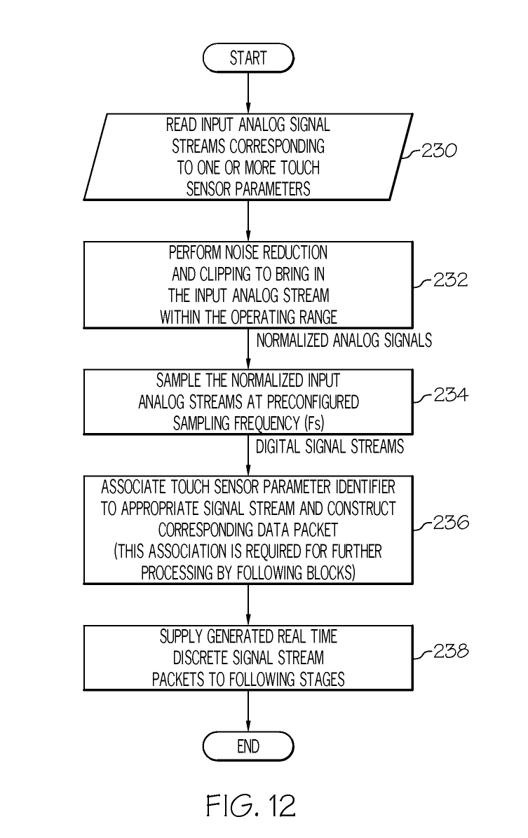

The above described input signal synthesis process is described in the flowchart shown in FIG. 12. The process begins when analog signal streams corresponding to one or more touch sensor parameters are read (STEP 230). In STEP 232, noise reduction and clipping is performed to bring the input analog signal stream within range for further processing. The normalized input signals are sampled at a predetermined sampling frequency (STEP 234). In STEP 236, a touch sensor parameter is associated with the digital signal stream and a data packet is constructed. The real time discrete signal stream packets are then provided to the following stages for subsequent processing (STEP 238).

Referring back to FIG. 6, the touch signal parameter stream from synthesizer 202 is provided to controller core 204, which controls overall processing, operating mode, dynamic and static configuration and manages timing, data, and control command input/output signals. As can be seen, controller core 204 may receive mode control and user application data and provide such user application data to a user interface element layout and system level performance requirements definition data base 206. Controller core 206 sends the discrete signal stream to touch signal spectrum analyzer 208 and positive interaction intent recognizer (PIIR) 210 in accordance with the mode settings. Touch signal spectrum analyzer 208 receives data from user interface event and system level performance requirements definition data base 212 and provides result and valid event description data to controller core 204.

Similarly, positive interaction intent recognizer 210 receives positive interaction intent descriptor definitive data from data base 214 and provides result and valid event description data to controller core 204. The touch signal spectrum analyzer 208 corresponds to the TSSA operating mode of the intelligent touch screen controller. It analyzes signals corresponding to one or more input touch sensor parameters and generates the above described results and user interface event descriptors, which are sent to controller core 204 for further processing. TSSA 208 refers to the touch signal parameter spectrum and system level performance requirements definition database 206 and the user interface element layout and system level performance requirements definitive database 212 as controlled by the sub-modes set by the user.

The positive interaction intent recognizer corresponds to the PIIR mode of operation. It analyzes input signals from controller core 204 corresponding to one or more touch sensor parameters and the positive interaction intent description definition database and generates the appropriate result and user interface event descriptors for transmission to controller core 204 for further processing.

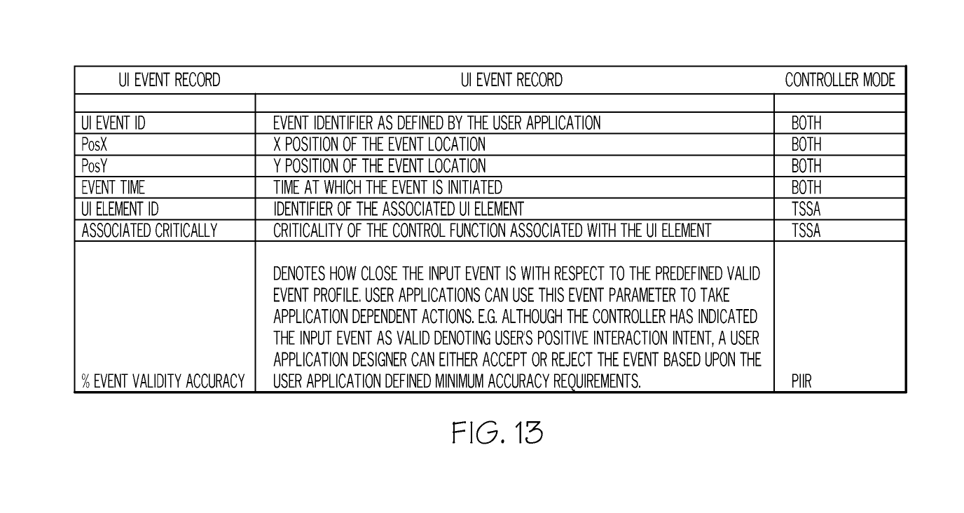

The user interface event generation engine receives touch event descriptors from controller core 204 and constructs user interface event data in a form understood by the user application software. The user interface event generated includes special mode dependent parameters that may be utilized by the user application for further refined decision making. See FIG. 13 which illustrates a user interface event record definition.

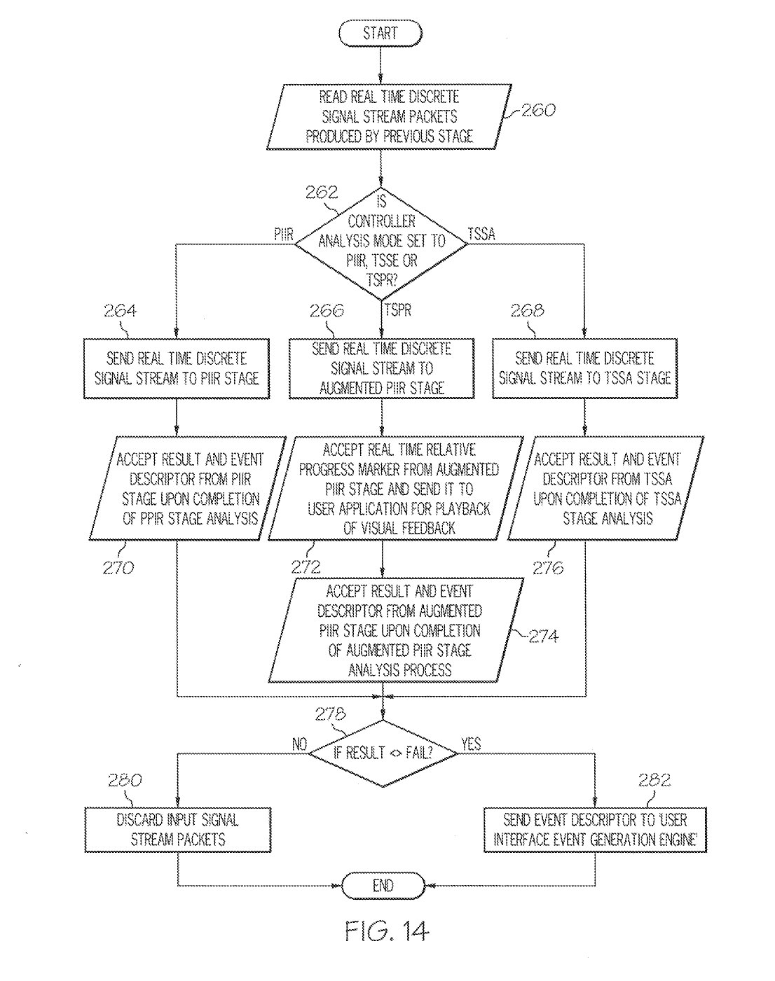

FIG. 14 is a flowchart of the controller core (204 in FIG. 6) algorithm. To begin, the controller core receives real time discrete signal stream packets (STEP 260) as previously described In STEP 262, the controller mode is determined; i.e. PIIR, TSPR (Touch Signal Parameter Profile Rules), or TSAA (Touch Parameter Signal Spectrum Analysis). It should be noted that the TSPR stage is in reality an augmented PIIR stage. If set to PIIR, the real time discrete signal stream is sent to the PIIR stage (STEP 264), and the result and event descriptor is determined upon completion of the PIIR stage analysis.

If the controller mode is set to TSPR, the real time discrete signal stream is sent to the augmented PIIR stage (STEP 266). In STEP 272, a real time relative progress marker is accepted and sent to the user application for visual playback (STEP 272). In STEP 274, the result and event descriptor is determined upon completion of the augmented PIIR stage analysis. If the TSSA mode is selected, the real time discrete signal stream is sent to the TSSA stage (STEP 268), and the result and event descriptor is accepted from the TSSA stage (STEP 276).

Regardless of which stage is selected, the result is tested (STEP 278) in accordance with criteria to be described below. If the result fails, the signal stream packets are discarded (STEP 280). If the results pass, the event descriptor is sent to the user interface event generation engine (261 in FIG. 6) (STEP 282).

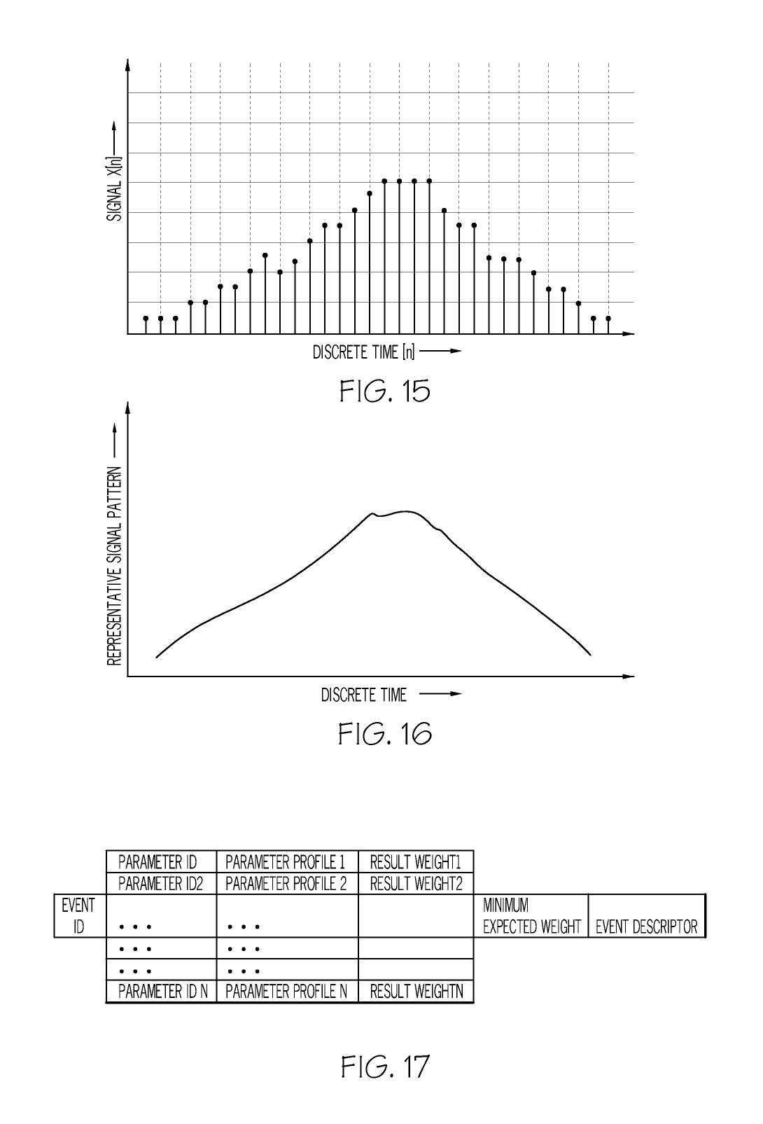

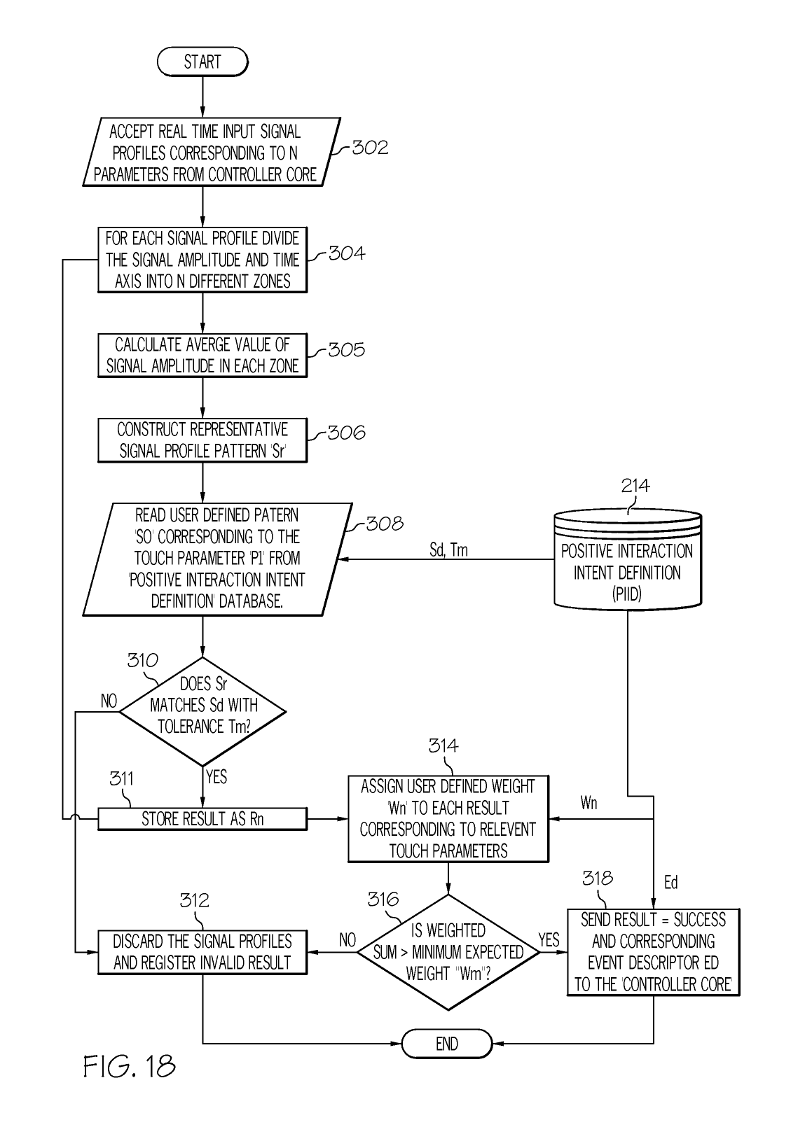

The positive interaction intent recognition (PIIR) algorithms will now be described in connection with FIGS. 6, 15, 16, 17, and 18 wherein FIG. 18 is a flowchart representative of the PIIR algorithm. As previously described, PIIR component (210 in FIG. 6) receives discrete signal profiles corresponding to one or more touch sensor parameters in packets from controller core (204 in FIG. 6; STEP 302 in FIG. 18). For each signal profile received, the signal amplitude and time axis is divided into N different zones as shown in FIG. 15 (STEP 304). This division into zones and grids facilitates the pattern recognition process. In STEP 306, an average amplitude value (A_{avg}) is calculated for each zone and a representative signal (Sᵣ) profile is constructed such as is shown in FIG. 16.

The newly constructed representative signal profile is compared with a corresponding predetermined signal profile (S_{D}) stored in positive interaction intent descriptor definition database (214 in FIG. 6) (STEP 308). If there is no match within a predetermined tolerance (Tₘ)(STEP 310), the signal profile is discarded and an invalid result is registered (STEP 312). If a match is found within acceptable tolerance limits, a weighted value (Wₙ) is assigned to the result corresponding to this match and the result is stored for further use (STEPS 310 and 314). The weighted value is received from PIID database 214 for corresponding touch sensor parameters as is shown in FIG. 17.

The above described process is repeated for all input discrete signal streams corresponding to various touch sensor parameters configured in the PIID database. When all results with weighted values are ready, a weighted average is calculated. If this value exceeds, within an acceptable tolerance, a minimum expected weight (Wₘ′)(STEP 316) configured in the PIIP database for this event, a SUCCESS will be declared, and the corresponding event descriptor (E_{d}) will be sent to controller core 204. If the weighted average does not exceed the minimum, within the tolerance, the results are discarded and an invalid result is registered (STEP 312).

Touch Signal Parameter Profile Rules (TSPR)

In this mode, various spatial, temporal and parametric rules are associated with the signal profiles corresponding to one or more touch sensor parameters rules (TPSP Rules) responsible for generating/constructing a user interface event. These interaction rules can be specified either dynamically or statically. These TPSP Rules define the touch sensor parameters signal profile patterns as a function of amplitude and time for corresponding control function activation. That is:

Rule=f(A[n],Dn)

where, A[n] is the signal amplitude at discrete time n; and Dn is the duration over which, the Amplitude A[n] remains acceptably constant.

This pattern or rule oriented touch interaction is associated with successful activation of a control function. However, these rules should be conveyed to the users intuitively without need of a special training on these rules. This interaction rule/pattern is associated with a progressive visual feedback designed to instruct the user to follow the expected interaction pattern. This progressive visual feedback is naturally followed by the user for successful control function activation without any additional training. In this mode, the user is required to induce touches corresponding to a preconfigured pattern/rule, with a configurable offset tolerance. Since, the existence of the pattern requires deterministic interaction; the probability of control function activation through spurious touches is reduced.

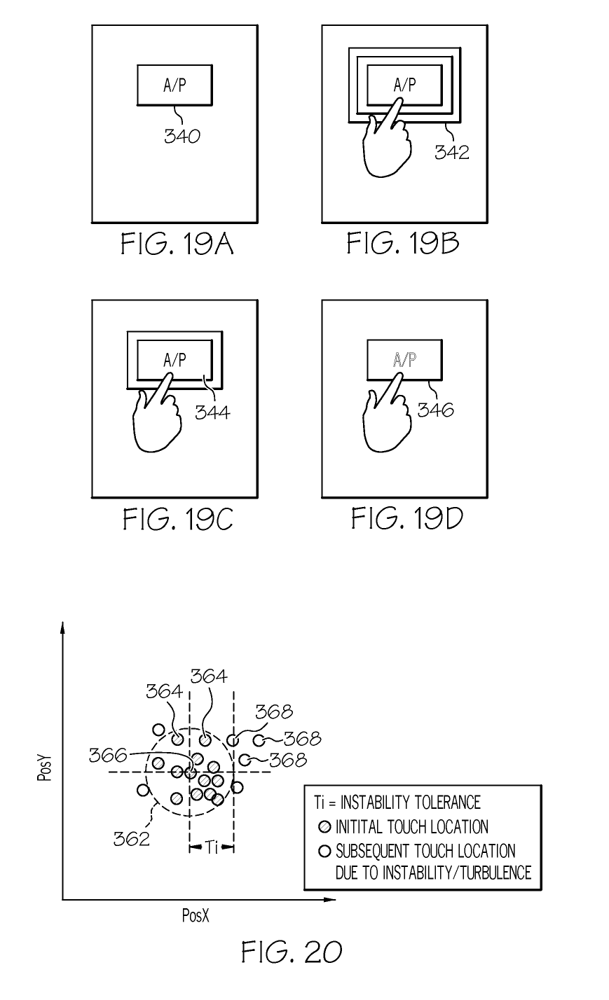

For example, a user interface (UI) element may appear as in FIG. 19A having a border 340 of a first color (e.g.) blue. When the button is initially touched, visual cues may appear in a second color (e.g. green) as rectangles of increasing dimensions 342 (FIG. 19B). If the user continues to touch the UI element, the button gradually increases in size (344 in FIG. 19C) to capture the visual cues. This will cause the user to intuitively continue to touch the UI button. In FIG. 19D, the button finally captures the last visual cue (346 in FIG. 19D), at which point the button changes to another color (e.g. magenta) to reflect a selected state. This change in color and state intuitively directs the user to release the button.

Using the above technique, the intelligent touch screen controller may account for control function significance and ease of activation. In addition, instability tolerance may be factored into the process to reject noise due to an unstable operating environment; e.g. during periods of turbulence. For example, referring to FIG. 20, the initial touch location is denoted 366. If the instability tolerance is T₁, then all subsequent touches 364 within circle 362 having a radius T₁ will be considered acceptable. Touches 368 outside the circle will be rejected. Thus, the concept of instability tolerance can be used to reject the noise in the touch locations induced due to instability in the interacting surface or the operating environment. Incorporating this concept helps issue valid touch events even though the touch inputs have acceptable irregularities in the touch location if they are placed acceptably close to each other.

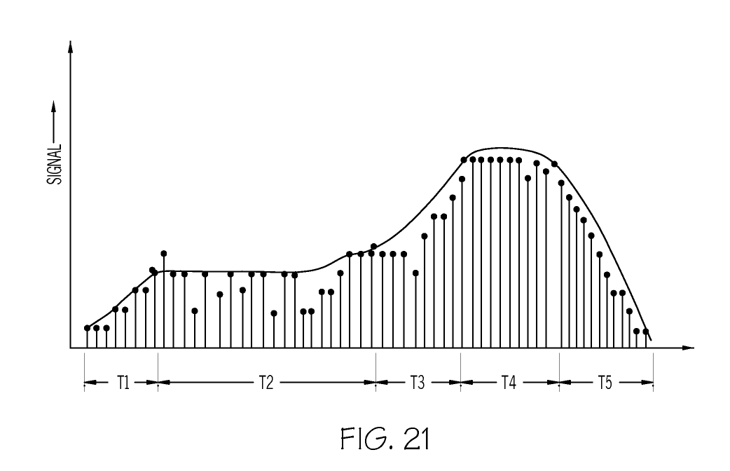

As previously stated, the TPSP rules are defined as a function of signal amplitude and time and define a signal profile pattern. Significant interface elements would have more stringent activation rules/patterns than the normal interface elements. For example, to activate the autopilot, a user might have to touch the corresponding button in accordance with the profile illustrated in FIG. 21 which comprises (a) a finger landing during time T1, (b) resting on the UI element for at least time T2, (c) increasing pressure during time T3, (d) remaining at the higher pressure for at least time (T4), followed by (e) a rapid finger removal during time T5.

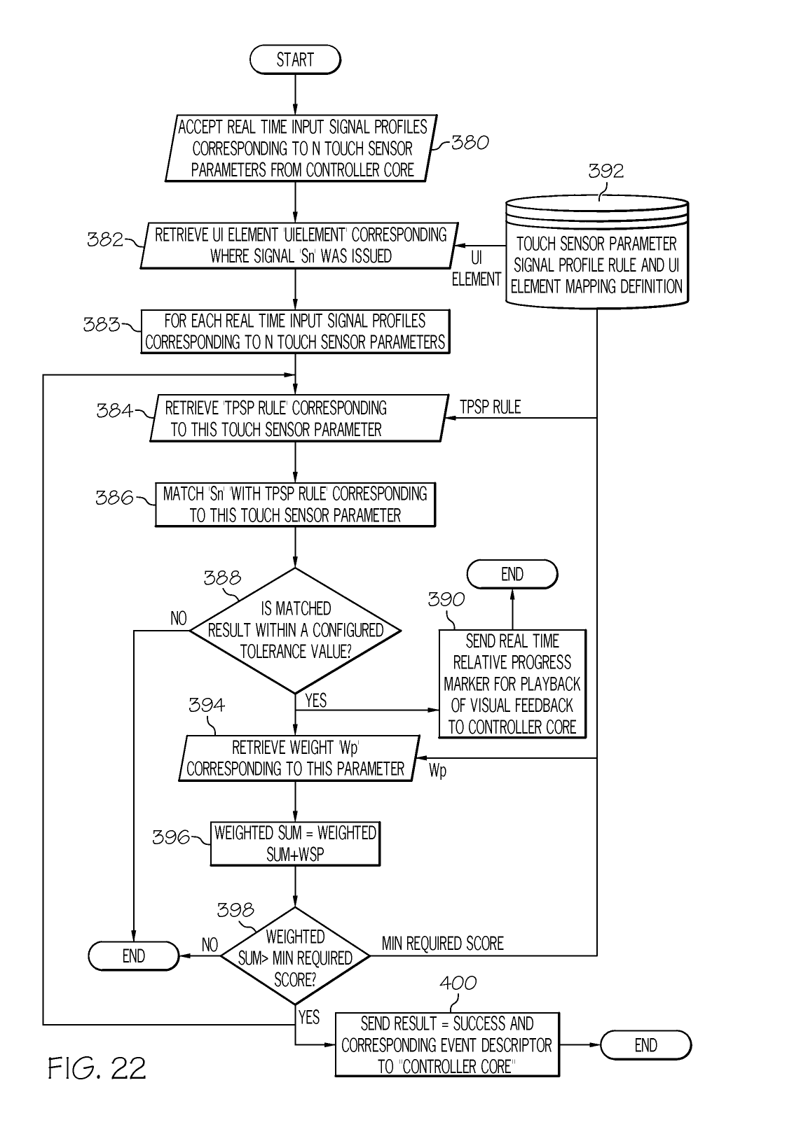

The above described touch signal parameter profile rules (TSPR) process is described in connection with the flowchart shown in FIG. 22. As was the case in the PIIR method, the process begins when the discrete signal profiles corresponding to one or more touch sensor parameters in packets are received from controller core (204 in FIG. 6) (STEP 380). Next, the UI element where the input signal Sₙ is located, is retrieved from the TSPR profile rule and user interface element mapping definition database. For each real time input signal profile (Sₙ) corresponding to N different touch sensor parameters (e.g. touch pressure, touch size, local sensitivity, etc.), the corresponding TSPR profile rule is then compared with the input signal profile (STEP 386). If there is a match with a predetermined tolerance, (STEP 388), a progress marker or visual feedback is provided to the controller core (STEP 390), which provides this visual data to the user. If there is no match, the process ends. Also, a minimum expected score (Wₚ)(percent match) is retrieved from TPSP database 392 for each touch sensor parameter (STEP 394).

In STEP 398, if the weighted sum is at least equal to a minimum required score provided by TSPS database 392, a SUCCESS will be declared and a corresponding event descriptor will be sent to the controller core (STEP 400).

Touch Parameter Signal Spectrum Analysis (TSSA)

In this operating mode, the proposed Intelligent Touch Screen Controller System provides an interface for associating one or more system level performance requirements pertaining to the control function or class of control functions, to one or more touch sensor parameter's dynamic characteristics. The system level performance requirements could be one or a combination of following properties: control function significance, ease of activation, and instability tolerance.

This operating mode includes first and second methods. In the first method, an interface enables the association of one or more System Performance Requirements to the User Interface Event used for activating a certain class of system control functions. The user interface events are generated only when signals corresponding to one or more touch sensor parameters responsible for constructing the event have minimum signal performance characteristics.

The second method enables the association of one or more system performance requirements to one or more “User Interface Elements” present in the system's UI layout. This component and the corresponding mode is responsible for generating user interface event, if the input signal stream (all or part as defined by the tolerance value) satisfies the dynamic signal behavior characteristics corresponding to the specified system performance requirement. This ensures that system control functions controlled by the particular user interface elements are activated/deactivated only when the corresponding user interface event's constituting components complies with the minimum performance requirements set by the respective user interface element. For example, higher significance level may be associated with buttons controlling radio modes, than a button controlling page navigation. In this case, the radio modes are activated only when the corresponding events issued to the respective buttons comply with the associated significance requirements.

These methods are carried out in conjunction with the touch signal spectrum analyzer (208 in FIG. 6) of the intelligent touch controller system. The input discrete signals corresponding to one or more touch sensor parameters are divided into various amplitude bands over the signal's dynamic range. This signal spectrum distribution definition for each touch sensor parameter type is stored in a touch signal parameter spectrum definition database contained in user interface event and system level performance requirements definition database 206 (FIG. 6).

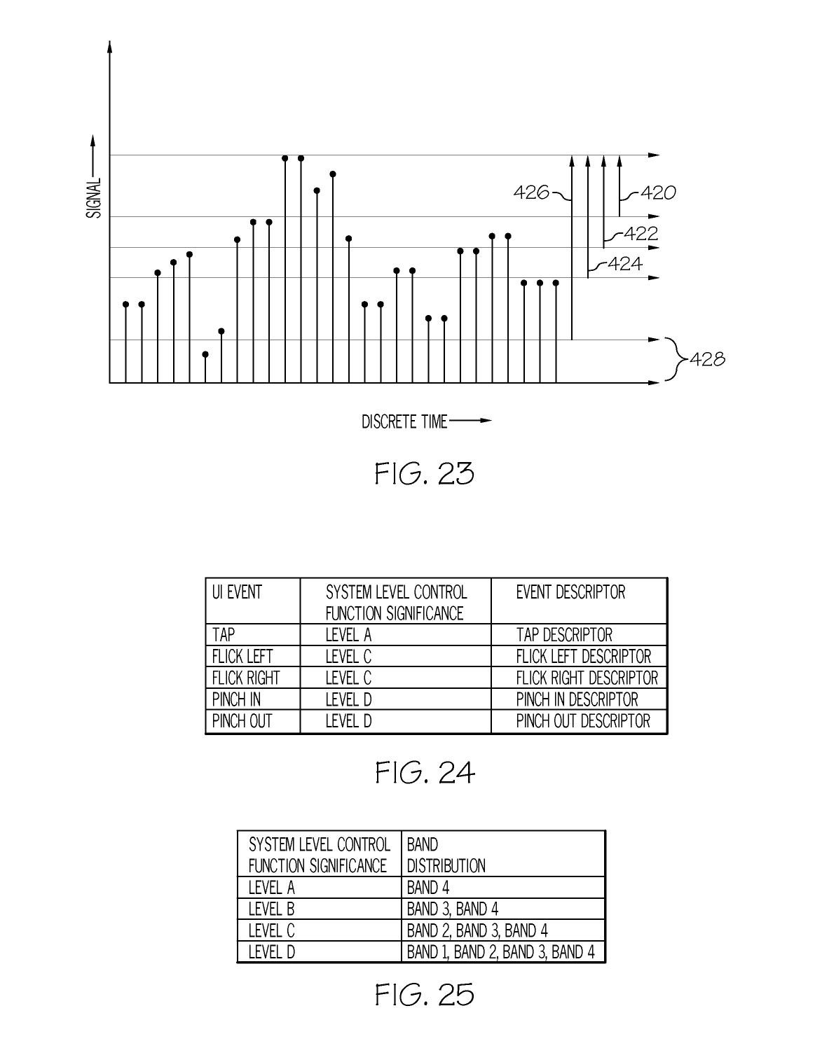

FIG. 23 illustrates an exemplary touch parameter signal dynamic range band distribution corresponding to various system level performance requirements. As can be seen, the discrete input signal is divided into four bands; band one 420, band two 422, band three 424, and band four 426. There is also a default dead band 428. From this point, the process may be event mode based or based on signal dynamic range. Each will be described using an exemplary system level requirement of control function significance for the sake of explanation only. It should be understood, however, that the method remains equally applicable for other system level requirements.

FIG. 24 illustrates an exemplary user interface and system control function significance map wherein level D has the lowest significance and level A has the highest significance. Thus, as can be seen, a level A event could be a “Tap” while level D event could be a “punch in” or “punch out” motion. Referring to FIG. 25, it can be seen that a level A event is associated with band 420 while a level D event is associated with band 426. This mode enables specification of which user interface events are significant from safety and reliability standpoints (FIG. 24). Based on their associated significance rating, the user interface events are generated only if the touch sensor parameters signals' minimum amplitude falls within and/or above predefined band.

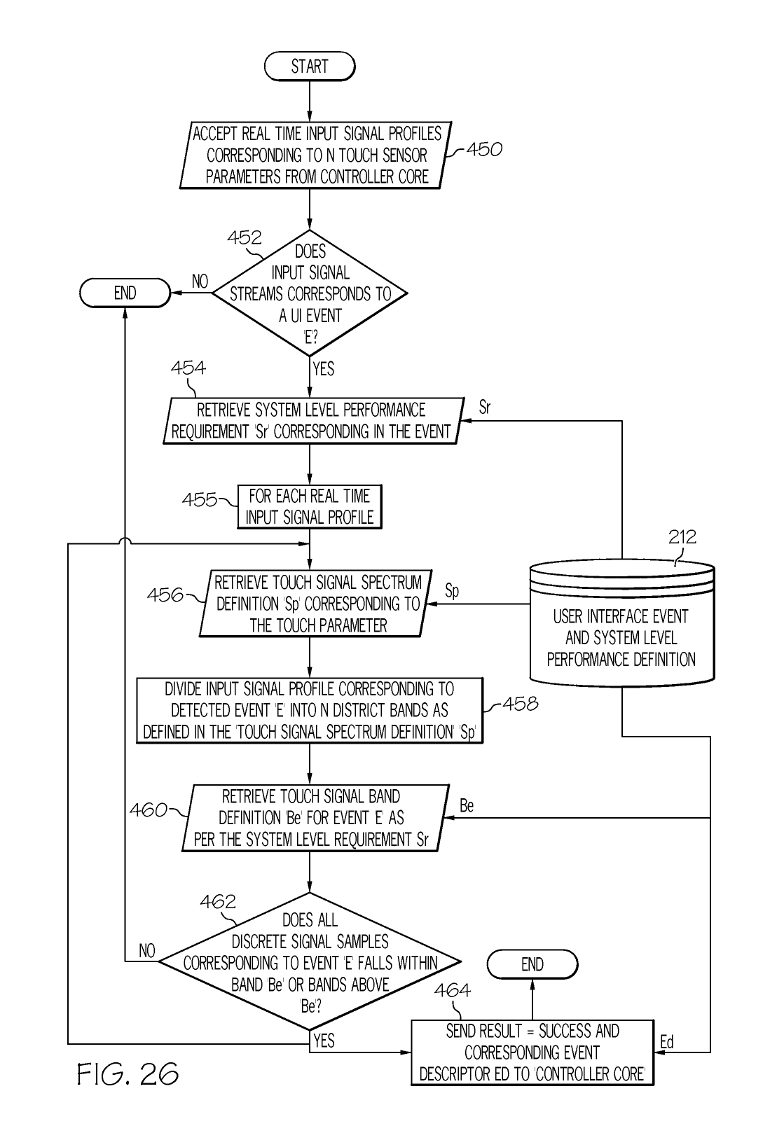

The above described TSSA process is described in connection with the flowchart shown in FIG. 26. As was the case previously, the process begins when the discrete signal profile corresponding to N touch sensor parameters are received from controller core (204 in FIG. 6) (STEP 450). If the input signal streams do not correspond to a UI event, the process ends (STEP 452). If the input signal streams do correspond to a UI event, the system level performance requirements corresponding to the event are retrieved from the user interface event and system level requirement database (212 in FIG. 6) for each real time input signal profile (STEP 454). After the touch signal spectrum definition corresponding to the touch parameter is received (STEP 456) from database 212, the input signal profile corresponding to the detected event is divided into N distinct bands as defined in the touch signal spectrum analyzer 208 (FIG. 6)(STEP 458). In STEP 460, the touch signal band definition for the event is retrieved. If all or a majority of the discrete signal samples corresponding to one or more touch sensor parameters required to generate the user interface event fall within the band corresponding to the event significance and/or bands corresponding to higher significance (STEP 462), then a SUCCESS will be declared and the corresponding Event Descriptor is sent to the controller core (STEP 464). STEPS 456-464 are repeated until all samples have been evaluated.

Thus, there has been provided systems and methods for reducing the effects of inadvertent touch on a TSC by (a) establishing valid touch interaction requirements that intelligently differentiate between intentional and unintentional touch and generates touch events accordingly, (b) associated performance requirements to various user interface event types or individual user interface elements, and/or (c) associates touch interaction rules to user interface elements for successful activation of the corresponding control function.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for detecting the inadvertent touch of a user interface element on a touch screen controller (TSC), comprising:
converting an analog signal stream associated with a plurality of touch sensor parameters into corresponding real-time, discrete signal stream packets;
selecting at least one of a plurality of modes for analyzing the discrete signal stream packets; and
processing the discrete signal stream packets in accordance with the at least one selected mode to determine if the user interface element has been inadvertently touched.

2. A method of claim 1 further comprising generating separate signal streams corresponding to various touch sensor parameters.

3. The method of claim 1 further comprising:
storing, in a first one of the plurality of modes, a predetermined signal profile in a first database; and
comparing a representative signal profile derived from the discrete signal stream with the predetermined signal profile.

4. The method of claim 3 further comprising dividing the input stream into a plurality of zones and grids to form the representative signal profile.

5. The method of claim 4 further comprising averaging the amplitude in each zone to form the representative signal profile.

6. The method of claim 1 further comprising associating a predetermined rule with a successful touch interaction in a second of the plurality of modes.

7. The method of claim 6 further comprising providing progressive visual feedback to a user.

8. The method of claim 7 further comprising inducing a user to perform touch in accordance with the predetermined rule.

9. The method of claim 8 further comprising rejecting touch resulting from environmental instability.

10. The method according to claim 9 further comprising rejecting touch resulting from instability by rejecting touch events beyond a predetermined radius from an initial touch location.

11. The method of claim 9 further comprising associating more stringent rules for activating control functions of greater significance.

12. The method of claim 1 further comprising, in a third of the plurality of modes, activating a control function via a user interface element when the representative signal profile spectrum complies with minimum performance requirements associated with the respective user interface element.

13. The method of claim 12 further comprising dividing the representative signal profile spectrum into a plurality of amplitude bands corresponding to various system level performance requirements.

14. The method of claim 13 further comprising generating a user interface event if the minimum amplitude of the representative signal profile falls within or above a predefined band.

15. A system for determining if a user has inadvertently touched a user interface element on a touch screen, comprising:
a plurality of touch sensors; and
a controller coupled to the plurality of touch sensors configured to (a) convert an analog input stream corresponding to a touch sensor parameter into a real-time signal profile; (b) receive a mode control signal indicative of which mode of a plurality of modes should be used to analyze the real time signal profile; and (c) process the real time signal profile using the selected mode to determine if the user interface element was inadvertently touched.

16. A system according to claim 15 wherein the controller is further configured to (a) store a predetermined signal profile in a first database; and (b) compare a representative signal profile derived from the real-time signal profile with the predetermined signal profile.

17. A system according to claim 15 wherein the processor is further configured to associate a predetermined rule with a successful touch interaction.

18. A system according to claim 15 wherein the controller is further configured to reject touch events beyond a predetermined radius from an initial touch location.

19. A system according to claim 15 wherein the controller is further configured to activate a control function via a user interface element when the representative signal profile spectrum complies with minimum performance requirements associated with the respective user interface element.

20. A method for determining if a user interface element on a touch screen was inadvertently touched, comprising:
converting an analog signal stream corresponding to a touch sensor parameter into a plurality of real-time, discrete signal stream packets;
storing a predetermined signal profile in a first database;
comparing a representative signal profile derived from the discrete signal stream with the predetermined signal profile;
associating a predetermined rule with a successful touch interaction; and
determining if the signal profile spectrum complies with minimum performance requirements associated with its respective user interface element.
